(19) United States
(12) Patent Application Publication
(10) Pub. No.: US 2013/0035224 A1
(43) Pub. Date: Feb. 7, 2013

(54) Method for Making an Aluminum Nitride Substrate

(71) Applicants: Yang-Kuao Kuo, Taoyuan County (TW); Chia-Yi Hsiang, Taoyuan County (TW); Bi-Jheng Chang, Taoyuan County (TW); Fu-Hsing Huang, Taoyuan County (TW)

(72) Inventors: Yang-Kuao Kuo, Taoyuan County (TW); Chia-Yi Hsiang, Taoyuan County (TW); Bi-Jheng Chang, Taoyuan County (TW); Fu-Hsing Huang, Taoyuan County (TW)

(73) Assignee: Chung-Shan Institute of Science and Technology, Armaments, Bureau, Ministry of National Defense, Taoyuan County (TW)

(21) Appl. No.: 13/237,213

(22) Filed: Sep. 20, 2011

(30) Foreign Application Priority Data
Aug. 4, 2011 (TW) 100127702

(51) Int. Cl. C04B 35/581; C04B 35/63; C04B 35/64

(52) U.S. Cl. 501/98.4

(57) ABSTRACT

Disclosed is a method for making an aluminum nitride substrate. At first, aluminum nitride is mixed with a carbonized material. The mixture is made into mixture powder in a granulation process. The mixture powder is sintered at an appropriate temperature so that the carbonized material reacts with oxygen to produce a gaseous carbon compound. The gaseous carbon compound is released, and hence an aluminum nitride substrate is made. Before the making of the aluminum nitride substrate is made, the aluminum nitride powder is mixed with the carbonized material. For the stable heat dispersion of the carbonized material, the heating is even during the sintering. The purity of the aluminum nitride substrate is high, the quality of the aluminum nitride substrate is good, and the size of the aluminum nitride substrate is large. Hence, the yield of the making of the aluminum nitride substrate is high.

### BACKGROUND OF INVENTION

1. Field of Invention

The present invention relates to an aluminum nitride substrate and, more particularly, to an inexpensive, efficient method for making an aluminum nitride substrate.

2. Related Prior Art

Conventional high-power LED devices generally include GaN substrates and Al₂O₃ substrates that emit blue light. The Al₂O₃ substrates are however poor regarding thermal conductivity as their heat transfer coefficients are 17 to 27 W/mK. Therefore, the conventional LED devices encounter a serious problem related to heat radiation when they are driven by large currents.

To solve the foregoing problem, various efforts have been made to develop highly thermally conductive aluminum nitride (“AlN”) substrates. The aluminum nitride substrates are highly thermally conductive as their heat transfer coefficients reach 170 W/mK. Furthermore, the aluminum nitride substrates are electrically isolative, erosion-resistant and refractory. The lives of the aluminum nitride substrates are long, and the physical properties of the aluminum nitride substrates are stable. Therefore, the aluminum nitride substrates can be used in the high-power electronic devices.

A conventional process for making an aluminum nitride substrate includes the steps of providing aluminum nitride powder, molding (or “forming”), sintering and finishing. Each of the steps influences the quality of a resultant aluminum nitride substrate. Each of the steps must be carefully chosen and parameters must be carefully determined.

In the conventional processing for making an aluminum nitride substrate, the step of sintering is a step of thermal activation and diffusion. The temperature must rise above a certain point to so that the sintering can occur. In the step of sintering, uneven heating and aggregation would affect the quality of the resultant aluminum nitride substrate regarding the porosity and the chip size.

Conventionally, the aluminum nitride substrates are limited to 4-inch aluminum nitride substrates for at least two reasons. Firstly, it is difficult and hence expensive to produce the aluminum nitride substrates. Secondly, it is difficult to control the quality of the aluminum nitride substrates. For example, the aluminum nitride substrates are vulnerable to cracks due to uneven heating during the sintering. Hence, it has not been any successful attempt to produce 8-inch wafer-class aluminum nitride substrates.

The present invention is therefore intended to obviate or at least alleviate the problems encountered in prior art.

### SUMMARY OF INVENTION

It is an objective of the present invention to provide an inexpensive, efficient method for making aluminum nitride.

To achieve the foregoing objective, the method includes the step of mixing aluminum nitride powder with a carbonized material to provide a mixture and the step of granulating the mixture into mixture powder.

In an aspect, the carbonized material is diamond powder or emery.

In another aspect, the step of granulating includes the step of pelletizing.

In another aspect, the step of granulating includes the step of screening.

It is another objective of the present invention to provide an inexpensive, efficient method for making an aluminum nitride substrate.

To achieve the foregoing objective, the method includes the steps of mixing aluminum nitride powder with a carbonized material to provide a mixture, granulating the mixture into mixture powder, and sintering the mixture powder. At a proper point of temperature, the carbonized material included in the mixture powder reacts with oxygen to produce a gaseous carbon compound that is released so that an aluminum nitride substrate is made.

In an aspect, the carbonized material is diamond powder or emery.

In another aspect, the step of granulating includes the step of pelletizing.

In another aspect, the step of granulating includes the step of screening.

In another aspect, the carbonized material reacts with oxygen to produce a gaseous carbon compound at 1100° C. to 1300° C.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a flow chart of a method for making an aluminum nitride substrate according to the preferred embodiment of the present invention;

FIG. 2 is a flow chart of a first step of the method for making an aluminum nitride substrate shown in FIG. 1;

FIG. 3 is a flow chart of a second step of the method for making an aluminum nitride substrate shown in FIG. 1; and

FIG. 4 is a flow chart of a third step of the method for making an aluminum nitride substrate shown in FIG. 1.

### DETAILED DESCRIPTION OF PREFERRED EMBODIMENT

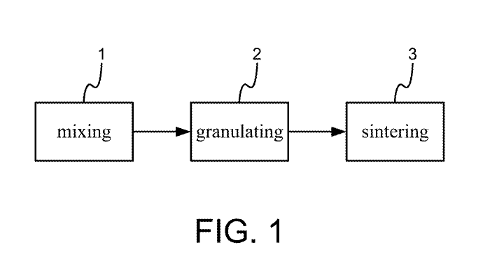

Referring to FIG. 1, there is shown a method for making an aluminum nitride substrate according to the preferred embodiment of the present invention. The method for making an aluminum nitride substrate includes the steps of mixing, granulating and sintering.

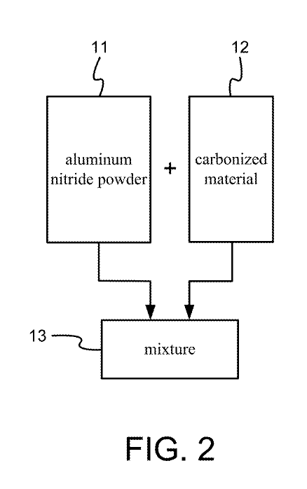

Referring to FIG. 2, at 1, aluminum powder 11 is mixed with carbonized material 12 to provide a mixture 13. The carbonized material 12 may be diamond powder or emery.

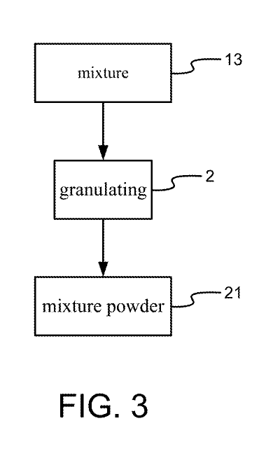

Referring to FIG. 3, at 2, the mixture 13 is granulated into mixture powder 21. The granulating may be pelletizing, or grinding and screening. The mixture powder 21 may be subject to the step of sintering, or used for any other appropriate applications.

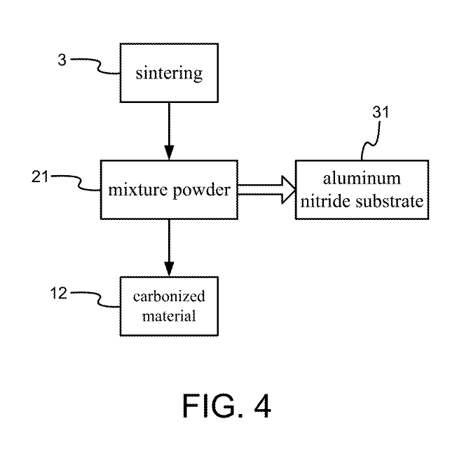

Referring to FIG. 4, at 3, the mixture powder 21 is subject to sintering. When the temperature for the sintering is 1100° C. to 1300° C., the carbonized material 12 included in the mixture powder 21 reacts with oxygen to produce a gaseous carbon compound such as carbon oxide. The gaseous carbon compound is released, and therefore an aluminum nitride substrate 31 is made. The purity of the aluminum nitride substrate 31 is high since all of the carbonized material 12 reacts with the oxygen to produce the gaseous carbon compound all of which is released from the aluminum nitride substrate 31.

The method for making an aluminum nitride substrate of the present invention exhibits at least three advantages.

At first, it is simple for including only a few steps.

Secondly, it improves the yield of the production of the aluminum nitride substrate 31. At the step of sintering, it effectively improves the evenness of the heating of the aluminum nitride substrate 31 to protect the aluminum nitride substrate 31 from cracks that would often occur should the heating is uneven. That is, the quality of the aluminum nitride substrate 31 is good.

Thirdly, it improves the purity of the aluminum nitride substrate 31. At the step of sintering, the carbonized material 12 reacts with the oxygen to produce the gaseous carbon compound that is released from the aluminum nitride substrate 31 into the environment. Therefore, the purity of the aluminum nitride substrate 31 is high. Accordingly, the method for making an aluminum nitride substrate can be used to make an 8-inched wafer-class aluminum nitride substrate.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for making aluminum nitride including the steps of:
mixing aluminum nitride powder 11 with a carbonized material 12 to provide a mixture 13; and
granulating the mixture 13 into mixture powder 21.

2. The method for making aluminum nitride according to claim 1, wherein the carbonized material 12 is selected from the group consisting of diamond powder and emery.

3. The method for making aluminum nitride according to claim 1, wherein the step of granulating includes the step of pelletizing.

4. The method for making aluminum nitride according to claim 1, wherein the step of granulating includes the step of screening.

5. A method for making aluminum nitride including the steps of:
mixing aluminum nitride powder 11 with a carbonized material 12 to provide a mixture 13;
granulating the mixture 13 into mixture powder 21; and
sintering the mixture powder 21, wherein at a proper point of temperature, the carbonized material 12 included in the mixture powder 21 reacts with oxygen to produce a gaseous carbon compound that is released so that an aluminum nitride substrate 31 is made.

6. The method for making aluminum nitride according to claim 5, wherein the carbonized material 12 is selected from the group consisting of diamond powder and emery.

7. The method for making aluminum nitride according to claim 5, wherein the step of granulating includes the step of pelletizing.

8. The method for making aluminum nitride according to claim 5, wherein the step of granulating includes the step of screening.

9. The method for making aluminum nitride according to claim 5, wherein the carbonized material 12 reacts with oxygen to produce a gaseous carbon compound at 1100° C. to 1300° C.
